(19) United States
(12) Patent Application Publication
(10) Pub. No.: US 2015/0269509 A1
(43) Pub. Date: Sep. 24, 2015

(54) SCHEDULE GENERATION DEVICE, SCHEDULE GENERATION METHOD, AND STORAGE MEDIUM

(71) Applicant: NEC CORPORATION, Minato-ku, Tokyo (JP)

(72) Inventors: Tomohito Ando, Tokyo (JP); Takashi Shiraki, Tokyo (JP)

(21) Appl. No.: 14/436,171

(22) PCT Filed: Jun. 25, 2013
(86) PCT No.: PCT/JP2013/067318

§ 371 Date: Apr. 16, 2015

(30) Foreign Application Priority Data
Oct. 31, 2012 (JP) 2012-241060

(51) Int. Cl. G06Q 10/06

(52) U.S. Cl. CPC G06Q 10/06311

(57) ABSTRACT

In a schedule generation device (1) which performs a process of grouping a plurality of movement tasks in the units of a plurality of processing target movement tasks to which a crewmember successively transfers, first, a plurality of movement tasks are divided into a plurality of groups so that no movement task is doubly included in a plurality of groups, a movement task included in each group at this time is determined as an on-duty movement task which is boarded for duty by a crewmember allocated with each group to carry out a predetermined duty, and then an off-duty movement task is included in a group which requires an off-duty movement task.

### TECHNICAL FIELD

The present invention relates to a schedule generation device, a schedule generation method, and a program.

### BACKGROUND ART

Patent Document 1 discloses a technique of creating a schedule for aircraft crewmembers. Specifically, the technique relates to a method in which a search space is reduced by using a predetermined method, and thus a high quality solution can be obtained in a short period of time.

### RELATED DOCUMENT

### Patent Document

[Patent Document 1] Japanese Laid-open Patent Publication No. 2001-92802

### DISCLOSURE OF THE INVENTION

An aircraft crewmember carries out his/her duty in a pattern in which the crewmember departs from a predetermined base (for example, Haneda Airport), changes flights a plurality of times, and returns to the base again. The plurality of flights to which the crewmember transfers include at least one flight (operation flight) to be boarded by the crewmember to carry out a predetermined duty (an operation or the like), and may also include a flight to be boarded as a passenger (deadhead flight) in order to move between airports without carrying out a predetermined duty.

Such a schedule for aircraft crewmembers may be created in a flow in which a plurality of flights are first grouped in the units of a plurality of flights (which include an operation flight and may include a deadhead flight) to which the crewmember successively transfers and then each group is allocated to the crewmember.

In the related art, for example, there is a problem in that it takes a lot of processing time to create a schedule for a crewmember in this flow, and thus it is desirable to reduce the processing time. Also in the technique disclosed in Patent Document 1, an effect thereof is not sufficient.

In addition, this problem may occur not only in creation of a schedule for aircraft crewmembers but also in creation of schedules for crewmembers of trains, ships, or other vehicles.

Therefore, an object of the present invention is to provide a technique for efficiently creating a schedule for crewmembers.

According to the present invention, there is provided a schedule generation device including a movement task information storage unit that stores a plurality of movement task information pieces each including a departure location, an arrival location, departure date and time, and arrival date and time of a movement task; and a grouping unit that groups processing target movement tasks specified by the plurality of movement task information pieces regarding processing targets in the units of the plurality of movement tasks to which a crewmember successively transfers, in which the plurality of movement tasks to which the crewmember successively transfers include at least one on-duty movement task which is the movement task to be boarded for duty by the crewmember to carry out a predetermined duty, and selectively include an off-duty movement task to be boarded by the crewmember for the purpose of movement without carrying out a predetermined duty, and in which the grouping unit performs a first process of grouping the processing target movement tasks so that no movement task is doubly included in a plurality of groups, and a second process of determining a movement task included in each of a plurality of groups generated through the first process as the on-duty movement task which is boarded for duty by the crewmember allocated with each group to carry out a predetermined duty and also of causing the movement task included in another group to be included as the off-duty movement task in a case where the off-duty movement task is necessary in a certain group.

In addition, according to the present invention, there is provided a program causing a computer to function as a movement task information storage unit that stores a plurality of movement task information pieces each including a departure location, an arrival location, departure date and time and arrival date and time of a movement task; and a grouping unit that groups processing target movement tasks specified by the plurality of movement task information pieces regarding processing targets in the units of the plurality of movement tasks to which a crewmember successively transfers, in which the plurality of movement tasks to which the crewmember successively transfers include at least one on-duty movement task which is the movement task to be boarded for duty by the crewmember to carry out a predetermined duty, and selectively include an off-duty movement task to be boarded by the crewmember for the purpose of movement without carrying out a predetermined duty, and in which the grouping unit performs a first process of grouping the processing target movement tasks so that no movement task is doubly included in a plurality of groups, and a second process of determining a movement task included in each of a plurality of groups generated through the first process as the on-duty movement task which is boarded for duty by the crewmember allocated with each group to carry out a predetermined duty and also of causing the movement task included in another group to be included as the off-duty movement task in a case where the off-duty movement task is necessary in a certain group.

Further, according to the present invention, there is provided a schedule generation method of causing a computer to store a plurality of movement task information pieces each including a departure location, an arrival location, departure date and time and arrival date and time of a movement task; and perform a grouping step of grouping processing target movement tasks specified by the plurality of movement task information pieces regarding processing targets in the units of the plurality of movement tasks to which a crewmember successively transfers, in which the plurality of movement tasks to which the crewmember successively transfers include at least one on-duty movement task which is the movement task to be boarded for duty by the crewmember to carry out a predetermined duty, and selectively include an off-duty movement task to be boarded by the crewmember for the purpose of movement without carrying out a predetermined duty, and in which the grouping step includes a first process of grouping the processing target movement tasks so that no movement task is doubly included in a plurality of groups, and a second process of determining a movement task included in each of a plurality of groups generated through the first process as the on-duty movement task which is boarded for duty by the crewmember allocated with each group to carry out a predetermined duty and also of causing the movement task included in another group to be included as the off-duty movement task in a case where the off-duty movement task is necessary in a certain group.

According to the present invention, it is possible to efficiently create a schedule for crewmembers.

### BRIEF DESCRIPTION OF THE DRAWINGS

The above-described object, and other objects, features, and advantages will be more apparent through a preferred exemplary embodiment described below and the following accompanying drawings.

FIG. 1 shows an example of a functional block diagram of a schedule generation device according to the present exemplary embodiment.

FIG. 2 is a flowchart showing an example of a flow of a process of a schedule generation method according to the present exemplary embodiment.

FIG. 3 is a flowchart showing an example of a flow of a process of a schedule generation method according to the present exemplary embodiment.

### DESCRIPTION OF EXEMPLARY EMBODIMENTS

Hereinafter, an exemplary embodiment of the present invention will be described with reference to the drawings.

In addition, a device according to the present invention is realized by any combination of hardware and software, focusing on a CPU of any computer, a memory, a program (including not only a program stored in advance in a memory from the shipment stage of the device but also a program downloaded from a storage medium such as a CD or a server on the Internet) loaded to the memory, a storage unit such as a hard disk storing the program, and a network connection interface. It should be understood by a person skilled in the art that a realization method and device may have various modifications.

In addition, a functional block diagram used for description of the present exemplary embodiment shows not a configuration in the hardware unit but a block in the function unit. In the drawings, each device is described to be realized by a single apparatus, but a realization method thereof is not limited thereto. In other words, both a physically separate configuration and a logically separate configuration may be employed.

First, a summary of the present exemplary embodiment will be described. In addition, in the present exemplary embodiment, a case of creating a schedule for aircraft crewmembers will be described as an example, but the present exemplary embodiment is also applicable to a case of creating schedules for crewmembers of trains, ships, or other vehicles.

As described above, an aircraft crewmember carries out a duty in a pattern in which the crewmember leaves a predetermined base (for example, Haneda Airport), transfers a plurality of flights, and returns to the base again. In addition, this pattern may be completed in a day or in several days.

Meanwhile, the plurality of flights to which the crewmember transfers include at least one flight (operation flight) to be boarded by the crewmember to carry out a predetermined duty (as a pilot or the like), and may also include a flight to be boarded as a passenger in order to move between airports without carrying out a predetermined duty (deadhead flight). For this reason, a schedule for aircraft crewmembers is required to be created in consideration not only of an operation flight but also of a deadhead flight.

A schedule for aircraft crewmembers may be created in a flow in which a plurality of flights are first grouped (grouping process) in the units of a plurality of flights (which include an operation flight and may include a deadhead flight) to which the crewmember successively transfers and then each group is allocated to the crewmember (allocation process).

In a case of grouping a plurality of flights in consideration of a deadhead flight, a certain flight may be doubly included in a plurality of groups. For example, there is a case where a certain flight is included in a single group as an operation flight and is also included in a single or a plurality of groups as a deadhead flight.

As an example of a grouping process performed in consideration of a deadhead flight, the following example may be considered, for example.

First, a plurality of flights (first flight group) corresponding to schedule creation processing targets are set as processing targets, and a plurality of flights to which a transfer can be successively made are combined with each other, so that a plurality of groups are created. In addition, in any group creation process, the whole of the first flight group is used as processing targets. In other words, a flight included in a certain group through the previous process is also included in a search space, and a certain flight is permitted to be doubly included in a plurality of groups.

Further, a plurality of groups are created so that all flights are included in one of the groups, and then an operation flight or s deadhead flight is allocated to each of the flights of each group. Specifically, an operation flight is allocated to a flight which is not doubly included in a plurality of groups. On the other hand, regarding a flight which is doubly included in a plurality of groups, an operation flight is allocated only to the flight included in a certain group, and a deadhead flight is allocated to the flight included in the other group. Then, whether or not a plurality of groups created in the above-described manner are an optimum solution is determined, and the grouping process is repeatedly performed until an optimum solution is obtained.

In a case of the process, since a search space in the grouping process includes a plurality of flights (first flight group) as schedule creation processing targets at all times, the search space is huge, and, as a result, a lot of process time is necessary.

The present inventor has made the invention for reducing the time required to create a schedule for aircraft crewmembers through a characteristic grouping process. Hereinafter, detailed description thereof will be made.

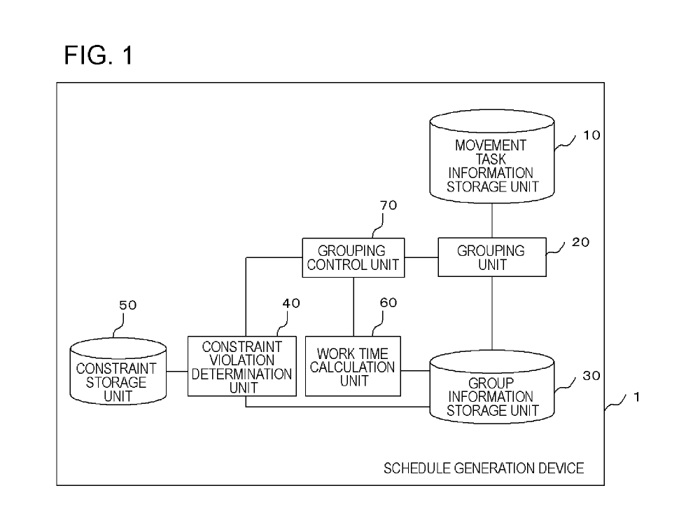

FIG. 1 shows an example of a functional block diagram of a schedule generation device according to the present exemplary embodiment. As shown in FIG. 1, a schedule generation device 1 includes a movement task information storage unit 10, a grouping unit 20, a group information storage unit 30, a constraint violation determination unit 40, a constraint storage unit 50, a work time calculation unit 60, and a grouping control unit 70. Hereinafter, each unit will be described.

The movement task information storage unit 10 stores a plurality of movement task information pieces including a departure location (an airport, a station, a harbor, or the like), an arrival location (an airport, a station, a harbor, or the like), departure date and time, and arrival date and time of a movement task. The movement task corresponds to a flight or the like of an aircraft.

The movement task information may include not only a departure location, an arrival location, departure date and time, and arrival date and time of a movement task, but also, for example, information for identifying the aircraft model for each flight.

The grouping unit 20 groups processing target movement tasks specified by a plurality of movement task information pieces regarding processing targets in a plurality of movement task units to which the crewmember successively transfers. The plurality of movement tasks to which the crewmember successively transfers includes at least one on-duty movement task which is a movement task to be boarded for duty by a crewmember to carry out a predetermined duty, and may include an off-duty movement task to be boarded by the crewmember for the purpose of movement without carrying out a predetermined duty. The predetermined duty is, for example, a flying operation, or attending to passengers.

The grouping unit 20 performs a process (a first process) of grouping processing target movement tasks so that no movement task is doubly included in a plurality of groups; and a process (a second process) of determining a movement task included in each of a plurality of groups generated through the grouping process as an on-duty movement task which is boarded for duty by a crewmember allocated with each group to carry out a predetermined duty and also of causing a movement task included in another group to be included as an off-duty movement task in a case where the off-duty movement task is necessary in a certain group. Consequently, the processing target movement tasks are grouped in a plurality of movement task units to which the crewmember successively transfers. In other words, first, the grouping is performed by using only an on-duty movement task, and an off-duty movement task is added to each group as necessary. In the first process, when a certain group has been generated and then another group is being further generated, a movement task included in the group which has already been generated is excluded from a grouping process target. In other words, in the first process, as the number of generated groups increases, a search space is reduced.

The time for the schedule creation process is considerably reduced by the grouping unit 20 which performs the grouping process in the above-described flow. Hereinafter, an example of a grouping process performed in the above-described flow will be described, but any process performed by the grouping unit 20 may be performed as long as the process satisfies the above-described flow, and such a process is not limited to an example described below.

The first process performed by the grouping unit 20 may include, for example, a process in which two movement tasks to which a transfer can be made, and/or two movement tasks to which a transfer can be made with another movement task interposed therebetween are connected to each other so that no movement task is doubly included in a plurality of groups, and may include a process of setting a plurality of connected movement tasks as a single group.

First, a description will be made of two movement tasks to which a transfer can be made.

For example, in a case where an arrival location of a first movement task matches a departure location of a second movement task, and the departure date and time of the second movement task are later than the arrival date and time of the first movement task, the grouping unit 20 may determine that the second movement task can be connected following the first movement task.

Alternatively, in a case where an arrival location of a first movement task matches a departure location of a second movement task, and the departure date and time of the second movement task are a predetermined time later than the arrival date and time of the first movement task, the grouping unit 20 may determine that the second movement task can be connected following the first movement task. The predetermined time may be set in consideration of the preparation time for transfer (for movement and the like in an airport).

In addition, a crewmember preferably works in aircrafts of the same model, and there is a case where such a rule is set. For this reason, in a case where the above-described conditions are satisfied, and the aircraft model of the first movement task (flight) matches the aircraft model of the second movement task (flight), the grouping unit 20 may determine that the second movement task can be connected following the first movement task. Further, there may be the presence of other conditions for determining that the second movement task can be connected following the first movement task.

Next, a description will be made of two movement tasks to which a transfer can be made with another movement task interposed therebetween.

For example, in a case where the following conditions (1) and (2) are satisfied, the grouping unit 20 may determine that a first movement task can be connected to a second movement task through a third movement task.

(1) An arrival location of the first movement task matches a departure location of the third movement task, and an arrival location of the third movement task matches a departure location of the second movement task.

(2) The departure date and time of the third movement task are later than the arrival date and time of the first movement task, and the departure date and time of the second movement task are later than the arrival date and time of the third movement task.

In addition, in a case where the following condition (2′) is satisfied instead of the condition (2), the grouping unit 20 may determine that a first movement task can be connected to a second movement task through a third movement task.

(2′) The departure date and time of the third movement task are predetermined time later than the arrival date and time of the first movement task, and the departure date and time of the second movement task are predetermined time later than the arrival date and time of the third movement task.

The predetermined time may be set in consideration of the preparation time for transfer (for movement and the like in an airport).

In addition, the third movement task may be a single task, or may be a plurality of movement tasks to which a transfer can be made. The plurality of movement tasks to which a transfer can be made as the third movement task satisfy at least the above-described conditions of a departure location and an arrival location, and conditions of the departure date and time and the arrival date and time.

In a case where the third movement task is a plurality of movement tasks to which a transfer can be made, the above conditions (1), (2) and (2′) may be reread as follows.

(1) An arrival location of the first movement task matches an initial departure location of a route connecting the plurality of movement tasks included in the third movement task, and a final arrival location of the route connecting the plurality of movement tasks included in the third movement task matches a departure location of the second movement task.

(2) The departure date and time of a movement task to be initially boarded among the plurality of movement tasks to which a transfer can be made included in the third movement task are later than the arrival date and time of the first movement task, and the departure date and time of the second movement task are later than the arrival date and time of a movement task to be boarded last among the plurality of movement tasks to which a transfer can be made, included in the third movement task.

(2′) The departure date and time of a movement task to be initially boarded among the plurality of movement tasks to which a transfer can be made included in the third movement task are a predetermined time later than the arrival date and time of the first movement task, and the departure date and time of the second movement task area predetermined time later than the arrival date and time of a movement task to be boarded last among the plurality of movement tasks to which a transfer can be made included in the third movement task.

In addition, in a case where a condition is satisfied that “the aircraft model of a first movement task (flight) matches the aircraft model of a second movement task (flight)” in addition to (1) and (2) or in addition to (1) and (2′), the grouping unit 20 may determine that the first movement task can be connected to the second movement task through the third movement task. The aircraft model of third movement task (flight) is not necessarily required to match the aircraft models of first and second movement tasks (flights). Further, there may be the presence of other conditions for determining that the second movement task can be connected following the first movement task through the third movement task.

The grouping unit 20 includes a process (a second process) of determining a movement task included in a group generated through the first process as an on-duty movement task which is boarded for duty by a crewmember allocated to the group to carry out a predetermined duty and also of causing a movement task which is not included in the group to be included as an off-duty movement task in a case where an off-duty movement task is necessary in the group.

For example, the grouping unit 20 determines whether or not both an initial departure location and a final arrival location of a transfer route of a plurality of movement tasks included in each group area predetermined base (for example, Haneda Airport) for each group. In addition, in a case where at least one of the initial departure location and the final arrival location is not the predetermined base, an off-duty movement task is caused to be included in the group, and both of the initial departure location and the final arrival location are set as the predetermined base. In other words, off-duty movement tasks to which a transfer can be made are included in the transfer route initially and/or last.

For example, it is assumed that a predetermined base is Haneda Airport, and a transfer route of movement tasks included in a certain group includes Hiroshima Airport, Nagoya Airport, Shizuoka Airport, and Haneda Airport in this order. In this case, the grouping unit 20 causes one or a plurality of flights which can be connected to flights of Hiroshima Airport as a departure location and Nagoya Airport as an arrival location, for example, a flight from Haneda Airport as a departure location to Hiroshima Airport as an arrival location, to be included in the group as an off-duty movement task, and sets a transfer route for the group to include Haneda Airport, Hiroshima Airport, Nagoya Airport, Shizuoka Airport, and Haneda Airport in this order.

Through the process, a transfer route for each group satisfies a pattern in which a crewmember departs from a predetermined base (for example, Haneda Airport), changes a plurality of flights, and returns to the base again.

In addition, the grouping unit 20 determines whether or not two movement tasks to which a transfer can be made with another movement task interposed therebetween are connected to each other for each group, and, in a case where two movement tasks to which a transfer can be made with another movement task interposed therebetween are connected to each other, an off-duty movement task to which a transfer can be made between the two movement tasks is caused to be included in the group.

Further, the grouping unit 20 may repeatedly perform grouping processes (the first process and the second process) on processing target movement tasks until an optimum solution is obtained. The repeated processes are controlled by the grouping control unit 70 described below.

The group information storage unit 30 stores information for identifying a movement task included in each of a plurality of groups generated by the grouping unit 20. In other words, the group information storage unit 30 stores information for identifying which movement task is in which group. In addition, the group information storage unit 30 stores the information so as to identify as which of an on-duty movement task and an off-duty movement task the movement task is included in each group.

The constraint storage unit 50 stores a constraint to be satisfied by a group having undergone the second process. A constraint is not particularly limited, but may be, for example, “an upper limit in a total of working hours in successive 24 hours (a total of hours of on-duty movement tasks) is A minutes”, “an upper limit in a total of the number of times of landing in successive 24 hours (a total of the number of times of landing of on-duty movement tasks) is B times”, “an upper limit in successive working days is C days (in a case of international flights)”, “an upper limit in successive working days is D days (in a case of domestic flights)”, “an upper limit in the number of times of transfer to flights as an off-duty movement task from a base is E times”, or “an upper limit in the number of times of transfer to flights as an off-duty movement task to a base is F times”. In addition, the above description is only an example, and the present invention is not limited thereto.

The constraint violation determination unit 40 sets groups generated through an N-th (where N is an integer of 1 or more) grouping process in the grouping unit 20 as processing targets, and determines whether or not there is a group which does not satisfy the constraint among the groups. In other words, the constraint violation determination unit 40 determines whether or not a constraint is violated for each of a plurality of grouping processes performed by the grouping unit 20, and obtains a result for each process. A determination result may be, for example, information for identifying whether or not a constraint is violated, and if violated, the number of violations or the content of a constraint violation. The constraint violation determination unit 40 inputs the determination result obtained for each grouping process performed by the grouping unit 20 to the grouping control unit 70.

The work time calculation unit 60 sets groups generated through an N-th (where N is an integer of 1 or more) grouping process in the grouping unit 20 as processing targets, and first calculates work time which is the time required for work of a plurality of movement tasks included in each group for each group. Then, the work time calculation unit 60 calculates a total time of work times of all the groups. In other words, the work time calculation unit 60 performs the process for each of a plurality of grouping processes performed by the grouping unit 20 so as to calculate a total time of work times.

The work time includes at least one of a movement time of a movement task calculated by using the departure date and time and the arrival date and time of each movement task (a time period from the departure date and time to the arrival date and time), a layover between movement tasks calculated by using the arrival date and time of a movement task and the departure date and time of a movement task which is connected following the movement task (a time period from the arrival date and time to the departure date and time), a so-called show-up time, and a so-called duty-off time.

The work time calculation unit 60 inputs the total time of work times calculated for each grouping process performed by the grouping unit 20, to the grouping control unit 70 to be described below. In addition, the work time calculation unit 60 may input an average time obtained by dividing the total time of work times by the number of groups, to the grouping control unit 70 to be described below, instead of the total time of work times.

The grouping control unit 70 causes the grouping unit 20 to repeatedly perform a grouping process until there is no group not satisfying the constraint and a total time of work times (or an average time) becomes an optimum value.

In other words, the grouping control unit 70 determines whether or not there is a group not satisfying the constraint and determines whether or not the total time of work times (or the average time) is an optimum value by using the information input from the constraint violation determination unit 40 and the work time calculation unit 60. In addition, in either or both cases where there is a group not satisfying the constraint and the total time of work times (or the average time) is not an optimum value, the grouping unit 20 is controlled to perform a grouping process on the processing target movement tasks again.

In addition, the grouping unit 20 performs a grouping process so that a result different from that in the previous grouping process is obtained during the grouping process performed again.

In other words, in the present exemplary embodiment, an optimum solution of a grouping process on processing target movement tasks is found through an interlocking process among the grouping unit 20, the group information storage unit 30, the constraint storage unit 50, the constraint violation determination unit 40, the work time calculation unit 60, and the grouping control unit 70. A method of finding an optimum solution is not particularly limited, and, for example, a method such as simulated annealing may be employed. For example, the grouping control unit 70 converts the determination result obtained from the constraint violation determination unit 40 into points according to a predetermined rule (design matter) and also converts the work time obtained from the work time calculation unit 60 into points according to a predetermined rule (design matter). In addition, an optimum solution of total points obtained by adding both the points together is obtained by using a method such as simulated annealing.

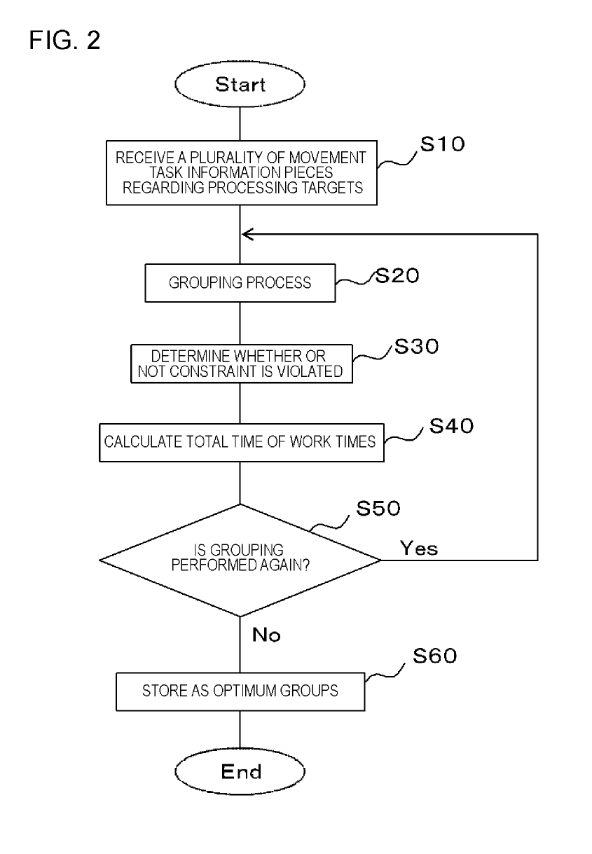

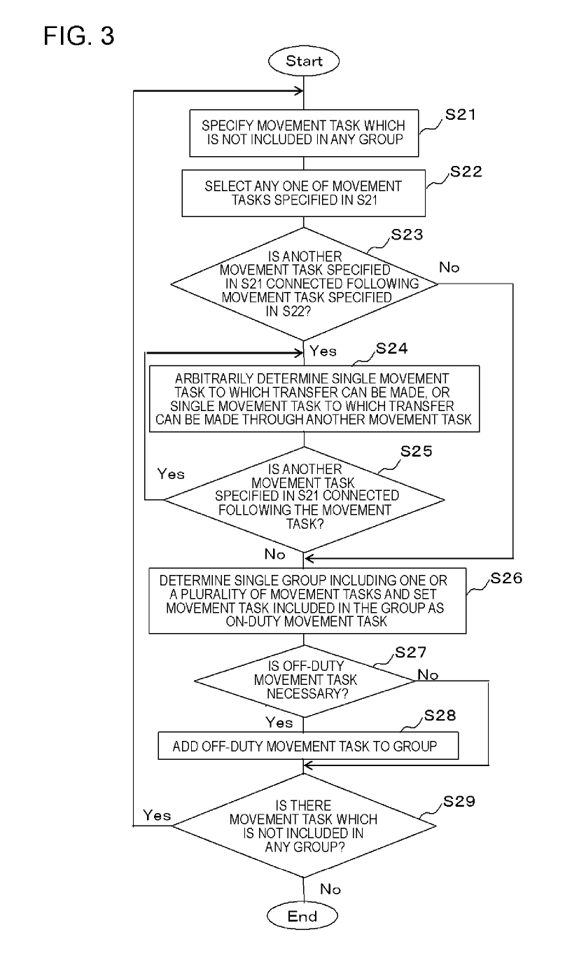

Next, with reference to flowcharts of FIGS. 2 and 3, a description will be made of an example of a flow of a process of a schedule generation method according to the present exemplary embodiment. In addition, the example described here is only an example, and a flow of a process of the schedule generation method according to the present exemplary embodiment is not limited thereto.

As illustrated in FIG. 2, first, the schedule generation device 1 receives a plurality of movement task information pieces regarding processing targets (step S10). Then, the grouping unit 20 performs a first grouping process on processing target movement tasks specified by the plurality of movement task information pieces received in step S10 (step S20).

Here, with reference to a flowchart of FIG. 3, a description will be made of an example of a flow of the grouping process.

First, the grouping unit 20 specifies a movement task which is not included in any group at that time among the processing target movement tasks (step S21). At the starting point of the process, there is no group generated earlier than that time, and thus the grouping unit 20 specifies all the processing target movement tasks as movement tasks which are not included any group.

Then, the grouping unit 20 selects any one of movement tasks specified in step S21 (step S22). Here, a movement task may be selected at random, and may be selected according to a predetermined rule (for example, a movement task of which the departure date and time is earliest). Hereinafter, the movement task selected here is referred to as a first selected movement task.

Next, the grouping unit 20 determines whether or not a movement task to which a transfer can be made is connected following the first selected movement task, or whether or not a movement task to which a transfer can be made is connected following the first selected movement task with another movement task interposed therebetween (step S23). Here, the determination may be performed at random, and may be performed according to a predetermined rule (for example, in a case where there is a movement task to which a transfer can be made at a predetermined time, connection is performed).

If it is determined that another movement task is not connected in step S23 (No in step S23), the grouping unit 20 sets a group which includes only the first selected movement task, and sets the first selected movement task in the group as an on-duty movement task (step S26). In other words, the grouping unit 20 sets a group which includes only the first selected movement task as an on-duty movement task. Then, the flow proceeds to step S27.

On the other hand, if it is determined that another movement task is connected in step S23 (Yes in step S23), the grouping unit 20 arbitrarily determines a single movement task to which a transfer can be made following the first selected movement task, or a single movement task to which a transfer can be made following the first selected movement task with another movement task interposed therebetween among the movement tasks specified in step S21 (step S24).

In a case where there are a plurality of movement tasks to which a transfer can be made following the first selected movement task, or a plurality of movement tasks to which a transfer can be made following the first selected movement task with another movement task interposed therebetween, the grouping unit 20 may determine a single movement task at random or according to a predetermined rule (for example, a movement task of which a layover between flights is shortest). Hereinafter, the movement task selected here is referred to as a second selected movement task.

Next, the grouping unit 20 determines whether or not a movement task to which a transfer can be made is connected following the second selected movement task, or whether or not a movement task to which a transfer can be made is connected following the second selected movement task with another movement task interposed therebetween (step S25). Here, the determination may be performed at random, and may be performed according to a predetermined rule (for example, in a case where there is a movement task to which a transfer can be made at a predetermined time, combination is performed).

If it is determined that another movement task is not connected in step S25 (No in step S25), the grouping unit 20 sets a group which includes only the first and second selected movement tasks as an on-duty movement task (step S26), and the flow proceeds to step S27.

On the other hand, if it is determined that another movement task is connected in step S25 (Yes in step S25), the flow returns to step S24, and the same process is repeatedly performed.

In step S27, the grouping unit 20 determines whether or not an off-duty movement task is necessary in the group set in step S26 (step S27).

If it is determined that an off-duty movement task is not necessary in the group (No in step S27), the grouping unit 20 stores information in which information regarding the group set in step S26, that is, information for identifying the group, is correlated with information for identifying the on-duty movement task included in the group, in the group information storage unit 30, and the flow proceeds to step S29.

On the other hand, if it is determined that an off-duty movement task is necessary in the group (Yes in step S27), the grouping unit 20 causes a movement task which is not included in the group to be included in the group as an off-duty movement task (step S28). In addition, the grouping unit 20 stores information regarding the group set in step S26 and information regarding the off-duty movement task added in step S28, in the group information storage unit 30, and the flow proceeds to step S29. In other words, the grouping unit 20 stores information in which information for identifying the group is correlated with information for identifying the on-duty movement task and the off-duty movement task included in the group, in the group information storage unit 30, and the flow proceeds to step S29.

In step S29, it is determined whether or not there is a movement task which is not included in any group among the processing target movement task groups. If there is a movement task (Yes in step S29), the flow returns to step S21, and the same process is repeatedly performed. On the other hand, if there is no movement task (No in step S29), the process of generating a group is finished, and the flow proceeds to step S30 of the flowchart illustrated in FIG. 2.

In addition, in the example described with reference to FIG. 3, a group is generated by connecting another movement task following the movement task specified in step S22, but a group may be generated by connecting another movement task prior to the movement task specified in step S22.

Further, in the example described with reference to FIG. 3, every time a single group is generated, it is determined whether or not an off-duty movement task is necessary (step S27), and an off-duty movement task is added as necessary (step S28), but the flow may directly proceed to step S29 without steps S27 and S28 after step S26. In other words, steps S27 and S28 may be omitted from the flowchart of FIG. 3. In addition, after a plurality of groups including only on-duty movement tasks are generated, that is, the process of the flowchart of FIG. 3 excluding steps S27 and S28 is finished, it may be determined whether or not an off-duty movement task is necessary for each group (step S27), and an off-duty movement task may be added as necessary (step S28).

Referring to FIG. 2 again, in step S30, the plurality of groups which are stored in the group information storage unit 30 and are generated through an N-th (for example, the latest) grouping process are set as processing targets, and the constraint violation determination unit 40 determines whether or not there is a group not satisfying the constraint among the processing target groups (step S30).

Next, in step S40, the plurality of groups which are stored in the group information storage unit 30 and are generated through an N-th (for example, the latest) grouping process are set as processing targets, and the work time calculation unit 60 calculates work time which is the time required in work of a plurality of movement tasks included in each group for each group, and calculates a total time of work times of all the groups (step S40). Further, a processing order of steps S30 and S40 is not particularly limited.

In step S50, the grouping control unit 70 determines whether or not the grouping unit 20 is caused to perform a grouping process again on the basis of the results calculated insteps S30 and S40. In addition, the grouping control unit 70 causes the grouping unit 20 to repeatedly perform a grouping process until there is no group not satisfying the constraint and the total time of work times becomes an optimum value.

If it is determined that the grouping unit 20 is caused to perform the grouping process again in step S50 (Yes in step S50), the flow returns to step S20 and the same process is repeatedly performed.

On the other hand, it is determined that the grouping unit 20 is caused not to perform the grouping process again in step S50 (No in step S50), the plurality of groups generated through the N-th (for example, the latest) grouping process are stored in the storage unit as optimum groups (step S60).

Then, the plurality of groups as the optimum groups are allocated to employees.

Next, operations and effects of the present exemplary embodiment will be described.

In the present exemplary embodiment, a plurality of movement tasks are divided into a plurality of groups so that no movement task is doubly included in a plurality of groups, and a movement task included in each group at this time is determined as an on-duty movement task which is boarded for duty by a crewmember allocated with each group. In other words, first, grouping is performed by using only an on-duty movement task.

Then, a movement task included in another group is included in a group which requires an off-duty movement task, as an off-duty movement task.

In a case of the present exemplary embodiment, in the process (a process of performing grouping by using only an on-duty movement task; a first process) of dividing a plurality of movement tasks into a plurality of groups so that no movement task is doubly included in a plurality of groups, a movement task which has already been included in any one of the groups can be excluded from a search space every time a group is generated. In other words, a search space can be reduced as the group generation process progresses. As a result, according to the present exemplary embodiment, it is possible to considerably reduce the time required to create a schedule.

### APPENDIXES

According to the above description, the following inventions are described.

<Invention 1>

A schedule generation device including:

a movement task information storage unit that stores a plurality of movement task information pieces each including a departure location, an arrival location, departure date and time and arrival date and time of a movement task; and

a grouping unit that groups processing target movement tasks specified by the plurality of movement task information pieces regarding processing targets in the units of the plurality of movement tasks to which a crewmember successively transfers,

in which the plurality of movement tasks to which the crewmember successively transfers include at least one on-duty movement task which is the movement task to be boarded for duty by the crewmember to carry out a predetermined duty, and may include an off-duty movement task to be boarded by the crewmember for the purpose of movement without carrying out a predetermined duty, and

in which the grouping unit performs a first process of grouping the processing target movement tasks so that no movement task is doubly included in a plurality of groups, and a second process of determining a movement task included in each of a plurality of groups generated through the first process as the on-duty movement task which is boarded for duty by the crewmember allocated with each group to carry out a predetermined duty and also of causing the movement task included in another group to be included as the off-duty movement task in a case where the off-duty movement task is necessary in a certain group.

<Invention 2>

The schedule generation device according to Invention 1,

in which, in the first process, the grouping unit divides the processing target movement tasks into a plurality of groups so that no movement task is doubly included in a plurality of groups by connecting two of the movement tasks to which a transfer can be made and/or two of the movement tasks to which a transfer can be made with another movement task interposed therebetween to each other.

<Invention 3>

The schedule generation device according to Invention 2,

in which, in the second process, the grouping unit determines whether or not both an initial departure location and a final arrival location of a transfer route of the plurality of movement tasks included in each group are a predetermined base for each group, and in a case where at least one of the initial departure location and the final arrival location is not the predetermined base, causes the off-duty movement task to be included in the group to set both of the initial departure location and the final arrival location as the predetermined base.

<Invention 4>

The schedule generation device according to Invention 2 or 3,

in which, in the second process, the grouping unit determines whether or not two of the movement tasks to which a transfer can be made with another movement task interposed therebetween are connected to each other for each group, and causes the off-duty movement task to which a transfer can be made to be included between the two movement tasks in the group in a case where the two movement tasks to which a transfer can be made with another movement task interposed therebetween are connected to each other.

<Invention 5>

The schedule generation device according to any one of Inventions 1 to 4, further including:

a group information storage unit that stores information for identifying the movement task included in each of a plurality of groups generated by the grouping unit.

<Invention 6>

The schedule generation device according to Invention 5,

in which the group information storage unit stores the information so as to identify whether the movement task included in each group is included as the on-duty movement task or the off-duty movement task.

<Invention 7>

The schedule generation device according to any one of Inventions 1 to 6,

in which the grouping unit is capable of repeatedly performing a grouping process including the first process and the second process on the processing target movement tasks, and

in which the schedule generation device further includes

a constraint storage unit that stores a constraint to be satisfied by a group having undergone the second process;

a constraint violation determination unit that sets groups generated through an N-th (where N is an integer of 1 or more) grouping process in the grouping unit as processing targets, and determines whether or not there is a group which does not satisfy the constraint among the groups;

a work time calculation unit that sets the groups as processing targets, calculates work time which is the time required for work for the plurality of movement tasks included in each group for each group, and calculates a total time of the work times of all the groups; and

a grouping control unit that causes the grouping unit to repeatedly perform the grouping process until there is no group not satisfying the constraint and the total time of work times becomes an optimum value.

<Invention 8>

The schedule generation device according to Invention 7,

in which the work time includes at least one of a movement time of the movement task calculated by using the departure date and time and the arrival date and time of each of the movement tasks, a layover between the movement tasks calculated by using the arrival date and time of the movement task and the departure date and time of a movement task which is connected following the movement task, a show-up time, and a duty-off time.

<Invention 9>

The schedule generation device according to any one of Inventions 1 to 8,

in which the movement task is a flight of an aircraft.

<Invention 10>

A program causing a computer to function as:

a movement task information storage unit that stores a plurality of movement task information pieces each including a departure location, an arrival location, departure date and time and arrival date and time of a movement task; and

a grouping unit that groups processing target movement tasks specified by the plurality of movement task information pieces regarding processing targets in the units of the plurality of movement tasks to which a crewmember successively transfers,

in which the plurality of movement tasks to which the crewmember successively transfers include at least one on-duty movement task which is the movement task to be boarded for duty by the crewmember to carry out a predetermined duty, and may include an off-duty movement task to be boarded by the crewmember for the purpose of movement without carrying out a predetermined duty, and

in which the grouping unit performs a first process of grouping the processing target movement tasks so that no movement task is doubly included in a plurality of groups, and a second process of determining a movement task included in each of a plurality of groups generated through the first process as the on-duty movement task which is boarded for duty by the crewmember allocated with each group to carry out a predetermined duty and also of causing the movement task included in another group to be included as the off-duty movement task in a case where the off-duty movement task is necessary in a certain group.

<Invention 10-2>

The program according to Invention 10,

in which, in the first process, the grouping unit divides the processing target movement tasks into a plurality of groups so that no movement task is doubly included in a plurality of groups by connecting two of the movement tasks to which a transfer can be made and/or two of the movement tasks to which a transfer can be made with another movement task interposed therebetween to each other.

<Invention 10-3>

The program according to Invention 10-2,

in which, in the second process, the grouping unit determines whether or not both an initial departure location and a final arrival location of a transfer route of the plurality of movement tasks included in each group are a predetermined base for each group, and in a case where at least one of the initial departure location and the final arrival location is not the predetermined base, causes the off-duty movement task to be included in the group to set both of the initial departure location and the final arrival location as the predetermined base.

<Invention 10-4>

The program according to Invention 10-2 or 10-3,

in which, in the second process, the grouping unit determines whether or not two of the movement tasks to which a transfer can be made with another movement task interposed therebetween are connected to each other for each group, and causes the off-duty movement task to which a transfer can be made to be included between the two movement tasks in the group in a case where the two movement tasks to which a transfer can be made with another movement task interposed therebetween are connected to each other.

<Invention 10-5>

The program according to any one of Inventions 10 to 10-4, causing the computer to further function as:

a group information storage unit that stores information for identifying the movement task included in each of a plurality of groups generated by the grouping unit.

<Invention 10-6>

The program according to Invention 10-5,

in which the group information storage unit stores the information so as to identify whether the movement task included in each group is included as the on-duty movement task or the off-duty movement task.

<Invention 10-7>

The program according to any one of Inventions 10 to 10-6,

in which the grouping unit is capable of repeatedly performing a grouping process including the first process and the second process on the processing target movement tasks, and

in which the program causes the computer to further function as

a constraint storage unit that stores a constraint to be satisfied by a group having undergone the second process;

a constraint violation determination unit that sets groups generated through an N-th (where N is an integer of 1 or more) grouping process in the grouping unit as processing targets, and determines whether or not there is a group which does not satisfy the constraint among the groups;

a work time calculation unit that sets the groups as processing targets, calculates work time which is the time required for work for the plurality of movement tasks included in each group for each group, and calculates a total time of the work times of all the groups; and

a grouping control unit that causes the grouping unit to repeatedly perform the grouping process until there is no group not satisfying the constraint and the total time of work times becomes an optimum value.

<Invention 10-8>

The program according to Invention 10-7,

in which the work time includes at least one of a movement time of the movement task calculated by using the departure date and time and the arrival date and time of each of the movement tasks, a layover between the movement tasks calculated by using the arrival date and time of the movement task and the departure date and time of a movement task which is connected following the movement task, a show-up time, and a duty-off time.

<Invention 10-9>

The program according to any one of Inventions 10 to 10-8,

in which the movement task is a flight of an aircraft.

<Invention 11>

A schedule generation method of causing a computer to:

store a plurality of movement task information pieces each including a departure location, an arrival location, departure date and time and arrival date and time of a movement task; and

perform a grouping step of grouping processing target movement tasks specified by the plurality of movement task information pieces regarding processing targets in the units of the plurality of movement tasks to which a crewmember successively transfers,

in which the plurality of movement tasks to which the crewmember successively transfers include at least one on-duty movement task which is the movement task to be boarded for duty by the crewmember to carry out a predetermined duty, and may include an off-duty movement task to be boarded by the crewmember for the purpose of movement without carrying out a predetermined duty, and

in which the grouping step includes a first process of grouping the processing target movement tasks so that no movement task is doubly included in a plurality of groups, and a second process of determining a movement task included in each of a plurality of groups generated through the first process as the on-duty movement task which is boarded for duty by the crewmember allocated with each group to carry out a predetermined duty and also of causing the movement task included in another group to be included as the off-duty movement task in a case where the off-duty movement task is necessary in a certain group.

<Invention 11-2>

The schedule generation method according to Invention 11,

in which, in the first process of the grouping step, the processing target movement tasks are divided into a plurality of groups so that no movement task is doubly included in a plurality of groups by connecting two of the movement tasks to which a transfer can be made and/or two of the movement tasks to which a transfer can be made with another movement task interposed therebetween to each other.

<Invention 11-3>

The schedule generation method according to Invention 11-2,

in which, in the second process of the grouping step, whether or not both an initial departure location and a final arrival location of a transfer route of the plurality of movement tasks included in each group are a predetermined base is determined for each group, and in a case where at least one of the initial departure location and the final arrival location is not the predetermined base, the off-duty movement task is caused to be included in the group to set both of the initial departure location and the final arrival location as the predetermined base.

<Invention 11-4>

The schedule generation method according to Invention 11-2 or 11-3,

in which, in the second process of the grouping step, whether or not two of the movement tasks to which a transfer can be made with another movement task interposed therebetween are connected to each other is determined for each group, and in a case where the two movement tasks to which a transfer can be made with another movement task interposed therebetween are connected to each other, the off-duty movement task to which a transfer can be made between the two movement tasks is caused to be included in the group.

<Invention 11-5>

The schedule generation method according to any one of Inventions 11 to 11-4, causing the computer to further perform:

a group information storage step of storing information for identifying the movement task included in each of a plurality of groups generated in the grouping step, in a storage device.

<Invention 11-6>

The schedule generation method according to Invention 11-5,

in which, in the group information storage step, the information is stored in the storage device so as to identify whether the movement task included in each group is included as the on-duty movement task or the off-duty movement task.

<Invention 11-7>

The schedule generation method according to any one of Inventions 11 to 11-6,

in which, in the grouping step, a grouping process including the first process and the second process can be repeatedly performed on the processing target movement tasks, and

in which the computer further performs

storing in advance a constraint to be satisfied by a group having undergone the second process;

a constraint violation determination step of setting groups generated through an N-th (where N is an integer of 1 or more) grouping process in the grouping step as processing targets, and determining whether or not there is a group which does not satisfy the constraint among the groups;

a work time calculation step of setting the groups as processing targets, calculating work time which is the time required for work for the plurality of movement tasks included in each group for each group, and calculating a total time of the work times of all the groups; and

a grouping control step of causing the grouping process to be repeatedly performed in the grouping step until there is no group not satisfying the constraint and the total time of work times becomes an optimum value.

<Invention 11-8>

The schedule generation method according to Invention 11-7,

in which the work time includes at least one of a movement time of the movement task calculated by using the departure date and time and the arrival date and time of each of the movement tasks, a layover between the movement tasks calculated by using the arrival date and time of the movement task and the departure date and time of a movement task which is connected following the movement task, a show-up time, and a duty-off time.

<Invention 11-9>

The schedule generation method according to any one of Inventions 11 to 11-8,

in which the movement task is a flight of an aircraft.

This application is based upon and claims the benefit of priority from Japanese Patent Application No. 2012-241060, filed Oct. 31, 2012; the entire contents of which are incorporated herein by reference.

What is claimed is:

1. A schedule generation device comprising:
a movement task information storage unit that stores a plurality of movement task information pieces each including a departure location, an arrival location, departure date and time and arrival date and time of a movement task; and
a grouping unit that groups processing target movement tasks specified by the plurality of movement task information pieces regarding processing targets in the units of the plurality of movement tasks to which a crewmember successively transfers,
wherein the plurality of movement tasks to which the crewmember successively transfers include at least one on-duty movement task which is the movement task to be boarded for duty by the crewmember to carry out a predetermined duty, and selectively include an off-duty movement task to be boarded by the crewmember for the purpose of movement without carrying out a predetermined duty, and
wherein the grouping unit performs a first process of grouping the processing target movement tasks so that no movement task is doubly included in a plurality of groups, and a second process of determining a movement task included in each of a plurality of groups generated through the first process as the on-duty movement task which is boarded for duty by the crewmember allocated with each group to carry out a predetermined duty and also of causing the movement task included in another group to be included as the off-duty movement task in a case where the off-duty movement task is necessary in a certain group.

2. The schedule generation device according to claim 1,
wherein, in the first process, the grouping unit divides the processing target movement tasks into a plurality of groups so that no movement task is doubly included in a plurality of groups by connecting two of the movement tasks to which a transfer can be made and/or two of the movement tasks to which a transfer can be made with another movement task interposed therebetween to each other.

3. The schedule generation device according to claim 2,
wherein, in the second process, the grouping unit determines whether or not both an initial departure location and a final arrival location of a transfer route of the plurality of movement tasks included in each group are a predetermined base for each group, and in a case where at least one of the initial departure location and the final arrival location is not the predetermined base, causes the off-duty movement task to be included in the group to set both of the initial departure location and the final arrival location as the predetermined base.

4. The schedule generation device according to claim 2, wherein, in the second process, the grouping unit determines whether or not two of the movement tasks to which a transfer can be made with another movement task interposed therebetween are connected to each other for each group, and in a case where the two movement tasks to which a transfer can be made with another movement task interposed therebetween are connected to each other, causes the off-duty movement task to which a transfer can be made between the two movement tasks to be included in the group.

5. The schedule generation device according to claim 1, further comprising:
a group information storage unit that stores information for identifying the movement task included in each of a plurality of groups generated by the grouping unit.

6. The schedule generation device according to claim 5,
wherein the group information storage unit stores the information so as to identify whether the movement task included in each group is included as the on-duty task or the off-duty movement task.

7. The schedule generation device according to claim 1,
wherein the grouping unit is capable of repeatedly performing a grouping process including the first process and the second process on the processing target movement tasks, and
wherein the schedule generation device further includes
a constraint storage unit that stores a constraint to be satisfied by a group having undergone the second process;
a constraint violation determination unit that sets groups generated through an N-th (where N is an integer of 1 or more) grouping process in the grouping unit as processing targets, and determines whether or not there is a group which does not satisfy the constraint among the groups;
a work time calculation unit that sets the groups as processing targets, calculates work time which is the time required for work for the plurality of movement tasks included in each group for each group, and calculates a total time of the work times of all the groups; and
a grouping control unit that causes the grouping unit to repeatedly perform the grouping process until there is no group not satisfying the constraint and the total time of work times becomes an optimum value.

8. The schedule generation device according to claim 7,
wherein the work time includes at least one of a movement time of the movement task calculated by using the departure date and time and the arrival date and time of each of the movement tasks, a layover between the movement tasks calculated by using the arrival date and time of the movement task and the departure date and time of a movement task which is connected following the movement task, a show-up time, and a duty-off time.

9. The schedule generation device according to claim 1,
wherein the movement task is a flight of an aircraft.

10. A non-transitory storage medium storing a program causing a computer to function as:
a movement task information storage unit that stores a plurality of movement task information pieces each including a departure location, an arrival location, departure date and time and arrival date and time of a movement task; and
a grouping unit that groups processing target movement tasks specified by the plurality of movement task information pieces regarding processing targets in the units of the plurality of movement tasks to which a crewmember successively transfers,
wherein the plurality of movement tasks to which the crewmember successively transfers include at least one on-duty movement task which is the movement task to be boarded for duty by the crewmember to carry out a predetermined duty, and selectively include an off-duty movement task to be boarded by the crewmember for the purpose of movement without carrying out a predetermined duty, and
wherein the grouping unit performs a first process of grouping the processing target movement tasks so that no movement task is doubly included in a plurality of groups, and a second process of determining a movement task included in each of a plurality of groups generated through the first process as the on-duty movement task which is boarded for duty by the crewmember allocated with each group to carry out a predetermined duty and also of causing the movement task included in another group to be included as the off-duty movement task in a case where the off-duty movement task is necessary in a certain group.

11. A schedule generation method of causing a computer to:
store a plurality of movement task information pieces each including a departure location, an arrival location, departure date and time and arrival date and time of a movement task; and
perform a grouping step of grouping processing target movement tasks specified by the plurality of movement task information pieces regarding processing targets in the units of the plurality of movement tasks to which a crewmember successively transfers,
wherein the plurality of movement tasks to which the crewmember successively transfers include at least one on-duty movement task which is the movement task to be boarded for duty by the crewmember to carry out a predetermined duty, and selectively include an off-duty movement task to be boarded by the crewmember for the purpose of movement without carrying out a predetermined duty, and
wherein the grouping step includes a first process of grouping the processing target movement tasks so that no movement task is doubly included in a plurality of groups, and a second process of determining a movement task included in each of a plurality of groups generated through the first process as the on-duty movement task which is boarded for duty by the crewmember allocated with each group to carry out a predetermined duty and also of causing the movement task included in another group to be included as the off-duty movement task in a case where the off-duty movement task is necessary in a certain group.
